(19) United States
(12) Patent Application Publication
(10) Pub. No.: US 2017/0039286 A1
(43) Pub. Date: Feb. 9, 2017

(54) Integrated data mining system architecture for extraction, processing and consumption of user data for customizing search engine output and other applications

(71) Applicant: Amrish J. Walke, Milpitas, CA (US)

(72) Inventors: Amrish J. Walke, Milpitas, CA (US); Vivek Bhagat, Jalandhar (IN); Dipinder Singh Sekhon, Gurgaon (IN); Ashwani Gautam, Delhi (IN)

(21) Appl. No.: 15/230,355

(22) Filed: Aug. 5, 2016

Related U.S. Application Data
(60) Provisional application No. 62/201,464, filed on Aug. 5, 2015.
(60) Provisional application No. 62/333,834, filed on May 10, 2016.

(51) Int. Cl. G06F 17/30; H04L 29/08

(52) U.S. Cl. CPC G06F 17/30867; H04L 67/10; G06F 17/30563

(57) ABSTRACT

The present invention discloses several embodiments of data mining architectures. Data mining architectures have components such as secure cloud servers hosting data warehouses, data modelers, analytics engines, and query engines. Systems comprising such data mining architecture process data extracted from user submitted data files in several formats, which could be massive datasets spread across multiple dimensions. Query engines have Application Programming Interfaces to communicate with external databases and services. Also disclosed are architectures and methods of accessing external databases that are located behind firewalls or have other security and privacy protections to mine additional data based on data from user submitted data files. The present invention can be used for applications such as customizing search engine output.

### CROSS-REFERENCE TO RELATED APPLICATIONS

This application claims benefit of U.S. Provisional Application No. 62/201,464 filed on 5 Aug. 2015 and 62/333,834 filed on 10 May 2016 which are incorporated by reference herewith in their entirety.

### BACKGROUND

Search engines customize search query results displayed on the search results webpage based on the user's profile and the overall statistics of a website. Typically, the user's profile is built using information from multiple sources e.g. data stored in a registered user's account (such as demographic data) and user's current state which includes information such as the user's location, web history, search history, social networks, and other easily accessible information. This current state information is typically collected through the browser cookies and used to display search results with some customization.

In many cases, user information is stored on databases that are located behind firewalls and have other security and privacy protections and are thus not easily accessible or usable by a search engine. Examples of such databases include financial transaction databases. Even if the user wants to add data from such databases to his profile database, there are no systems that can perform this action. Methods for accessing secured databases lack the necessary architecture to link users and search engines. They cannot be used for performing the abovementioned actions such as customizing search engine output.

Thus, there is an unmet need for systems and methods that can access secured databases to mine data and build the user's profile on a profile database to provide more relevant customized products and services (e.g. search engine output, advertisements displayed on web pages, electronic maps, layouts of electronic catalogues, etc.) based on the information in the profile database. In addition, there is an unmet need for systems and methods that can aggregate data from multiple sources such as user uploaded data files containing data in different formats and their profiles from social media platform and mine data from these sources, which can be massive datasets spread across multiple dimensions. There is a need for systems and methods can perform above actions with minimal effort from the user.

### SUMMARY

The present invention discloses several embodiments of data mining architectures for extraction, processing and consumption of user data. They may be used for a variety of actions including modifying the output of a search engine. Embodiments of the present system have parsing engines that process user's data. Post parsing, the user's data may be passed through a series of transformations to convert it to serializable format before storing it to a data warehouse. A variety of systems disclosed herein have data mining architectures containing components such as secure cloud servers hosting data warehouses, data modelers, ETL tools, analytics engines, and query engines. The invention may use one or more data mining systems and techniques to aggregate data from multiple sources and process the data for deriving meaningful patterns about the user's behavior. Query engines have Application Programming Interfaces to communicate with external databases and services.

Various embodiments of data access interfaces are disclosed that can be used by external service providers/partners to access data stored in one or more databases of the system. Several embodiments of the system comprise means for integration with external service providers/partners who have access to secured databases. Also disclosed are architectures and methods for integration with external service providers/partners for accessing external secured databases that are located behind firewalls or have other security and privacy protections to mine additional data based on data extracted from user submitted data files. The invention also discloses systems and methods of adding data from secured databases to the user's profile without compromising the security of the secured databases.

Other embodiments and details are described in the detailed description below.

### BRIEF DESCRIPTION OF THE FIGURES

FIG. 1 shows an embodiment of the data mining system architecture of the present invention.

FIG. 2 shows a first alternate embodiment of the data mining system architecture of the present invention.

FIG. 3 shows a second alternate embodiment of the data mining system architecture of the present invention.

FIGS. 4 and 5 show two embodiments of data access interfaces.

FIGS. 6 and 7 shows two embodiments of the architecture and the data flow of using the present invention to improve search engine results.

FIG. 8 shows one embodiment of a data flow of a system incorporating an External Service.

FIG. 9 shows another embodiment of a data flow of a system incorporating an External Service.

FIG. 9A shows a flowchart of a method of adding data from an external secured database to the user's profile stored on a TWIRO system without compromising the security of the database.

FIG. 98 shows FIG. 2 of U.S. Pat. No. 8,438,061 (prior art).

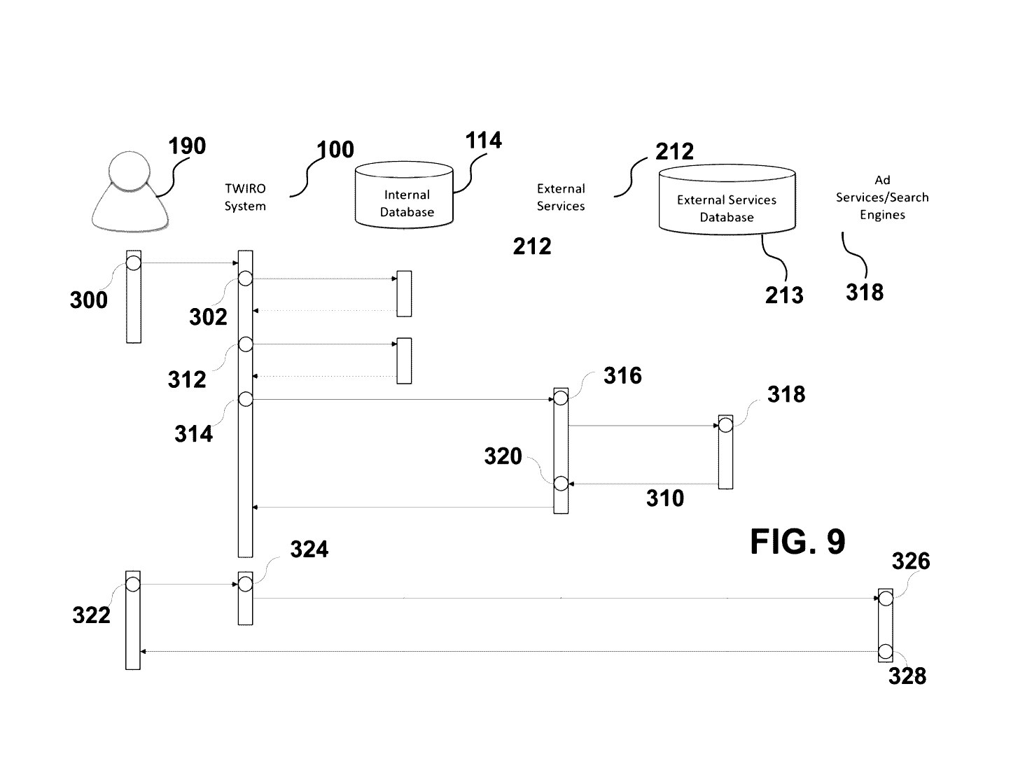

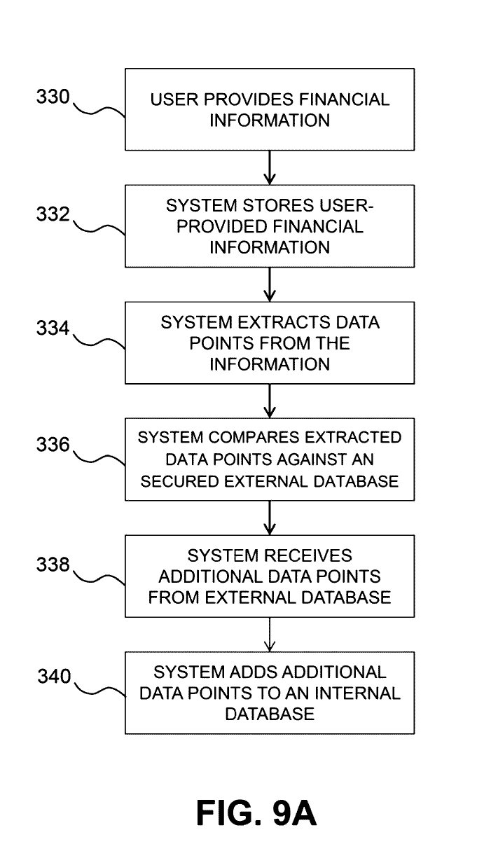

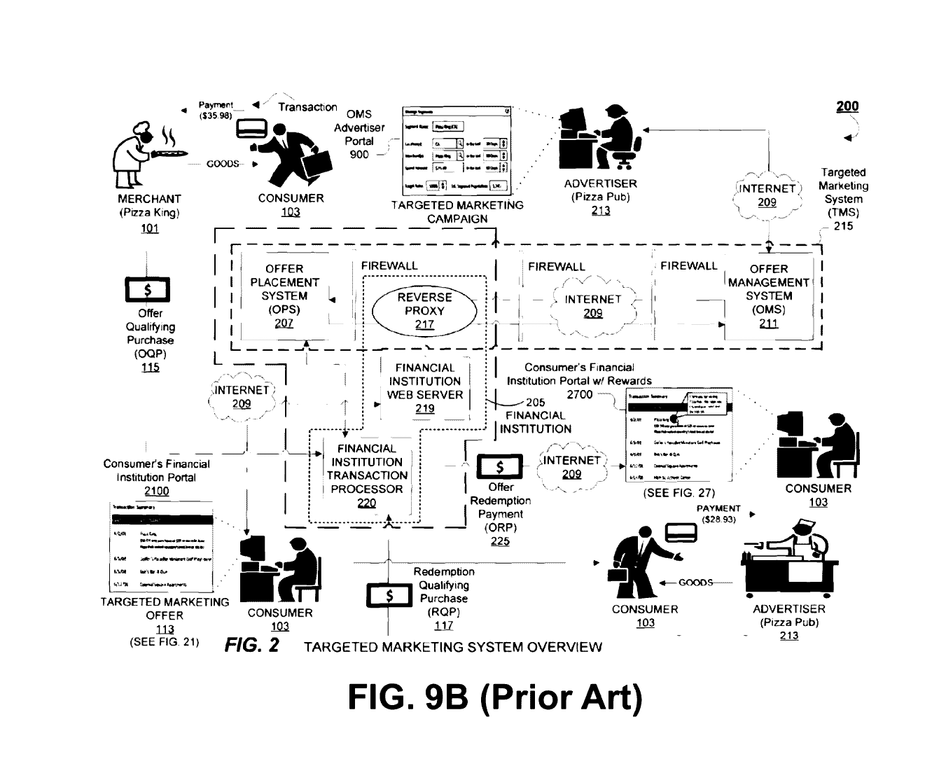

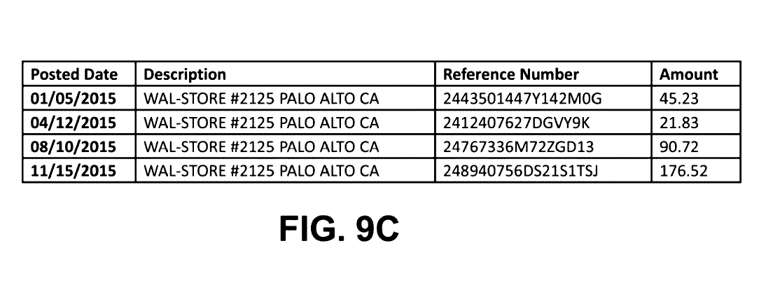

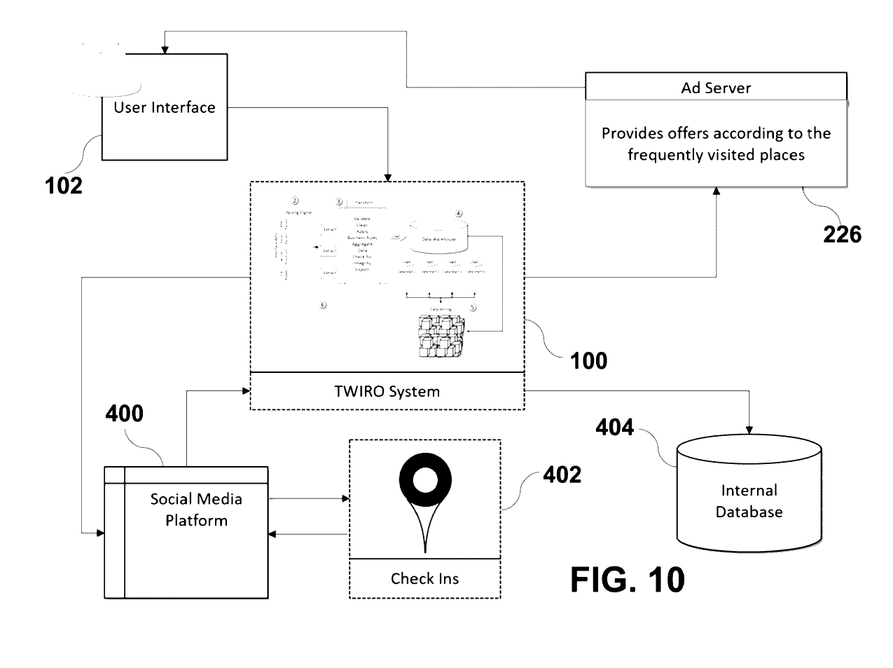

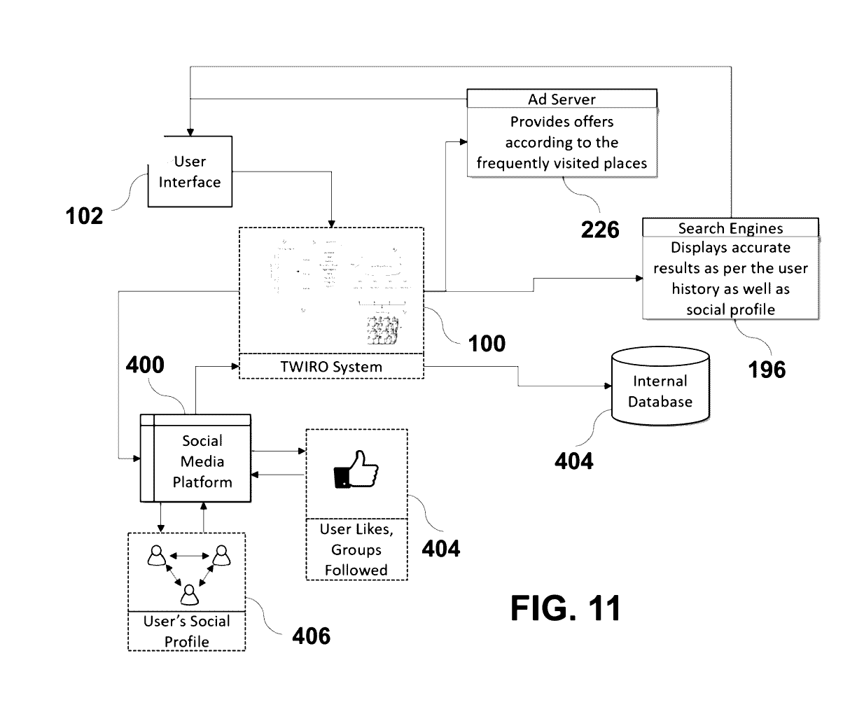

FIG. 9C shows a table of data extracted from a credit card statement showing the user's financial transactions with a particular hypothetical store.

FIGS. 10 and 11 show two embodiments of a system comprising a social media interface.

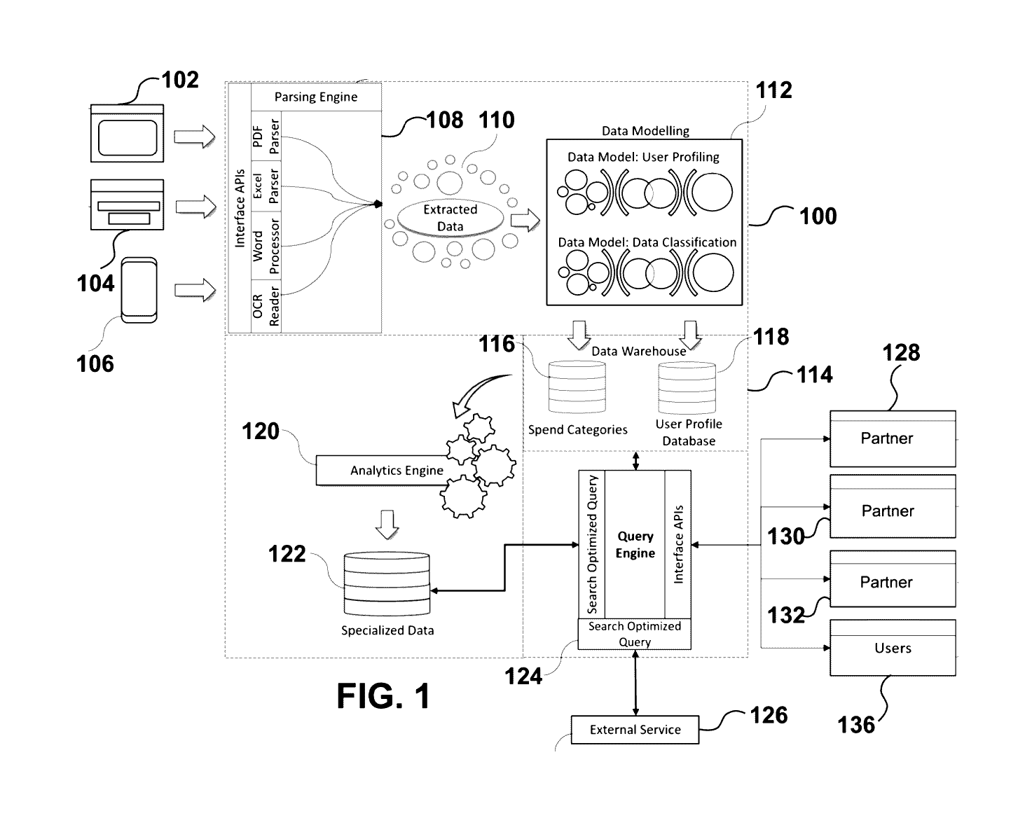

FIG. 1 shows an embodiment of the data mining system architecture of the present invention.

### DETAILED DESCRIPTION

FIG. 1 shows an embodiment of the data mining system architecture of the present invention. The architecture shown as system 100 (also called TWIRO in this specification) is used for extraction, processing, and consumption of user data which is then used for customizing search engine output and other applications as disclosed in this specification. Components of system 100 may be hosted on secure cloud servers (e.g. secure cloud servers) comprising a processor and data storage means.

System 100 interfaces with a variety of upload mechanisms that are used by a user to perform a user initiated electronic transaction such as uploading documents in a variety of file formats to a web server. The user may be an individual, groups of individuals, businesses, etc.

The user may sequentially select and transfer only particular selected information (from a pool of information) to system 100. The user may transfer specific information to system 100 through one or more user-initiated transfers. In one such embodiment, the user provided information is transferred to system 100 using a single action. In one embodiment, the user decides which information to upload, drags and drops one or more files and/or folders into a upload mechanism, and uploads the information to system 100 which in turn generates a user profile. Examples of upload mechanisms include, but are not limited to:

1. Web Browser Plugin 102: Plugins for specific browsers e.g. Chrome, Firefox, etc. may be used to upload user data. The plugin comprises means for enabling the user to perform the following actions: upload specified/selected files to system 100, manage user' profile with TWIRO, register for services, manage permissions and avail offers from TWIRO's partners, etc. Examples of file formats and types are disclosed elsewhere in the specification. They include, but are not limited to: credit card and other financial statements; mobile, restaurant and other bills; resume; etc. for building the user's profile on system 100. The plugin may further be used by TWIRO to authenticate and identify the user and send user relevant data to partners and search engines.

2. Desktop application 104 installed on the local system (e.g. on a personal electronic device) of the user: In one embodiment, desktop application 104 is a .net based application written in Visual C#. Other coding languages may be used depending on the actual implementation. Desktop application 104 comprises means for enabling the user to perform one or more of the actions mentioned for web browser plugin 102.

3. Mobile application 106: Mobile application 106 may support Android as well as iOS operating systems. Mobile application 106 may be written as per the SDK for the development platforms and deployed in the Play store and iTunes App Store for Android based phones and iPhone respectively. Mobile application 106 comprises means for enabling the user to perform one or more of the actions mentioned for web browser plugin 102. The application may comprise features to upload different file formats supported by desktop application 104. Mobile application 106 may comprise means to give the user an option to take a picture of a bill and upload the same to the system 100. In one such embodiment, mobile application 106 provides onscreen instructions to take a picture in the appropriate format that is readable by a server. Mobile application 106 comprises means for enabling the user to perform one or more of the actions mentioned for web browser plugin 102.

4. A webpage. E.g. A web page with an interface to allow the user to upload files by “dragging & dropping” files to an upload field on the webpage.

In another embodiment, the user authorizes (using paper or electronic means) system 100 to access user's information from external databases (e.g. a DNA sequence located on database of a company like 23andme) and/or transfer that information to system 100. System 100 then accesses the server and obtains the authorized information.

System 100 comprises a parsing engine 108 for reading data files uploaded by the user to the TWIRO Server. System 100 may comprise multiple parsers for reading and extracting the data from different file types. Examples of such file types include, but are not limited to: PDF, Word, Excel and Images. In one embodiment, the file type may be specified by the system 100 or the user during upload. In one embodiment, parsing engine 108 reads transactional data as well as metadata and stores them in a document oriented database.

Examples of data contained in one or more data files uploaded by or otherwise provided by the user to system 100 include, but are not limited to:
Financial information e.g.
   Statements (e.g. credit card statements, bank or other financial account statements, etc.)
   Reports
   Financial transaction history
Bills, receipts e.g.
   Using an app on a smartphone to scan receipts or bills
Websites of interest (select relevant information, drag and drop to a user interface),
Login and passwords to social networking websites such as LinkedIn, Facebook, Google Plus
An archive or other summary/whole of a user's personal data on websites such as Facebook. This may be downloaded or otherwise obtained from the website (e.g. through a request from the user). One example of this is data obtained through “Download a copy of your Facebook data” function of Facebook.
Information obtained from another website or a third party database after the user provides permission to the website/third party database to transfer the user's data stored there to the processing system.
Information obtained from another website or a third party database after the user provides permission to the processing system to access the user's data stored there. E.g. the user may provide a profile-based website such as LinkedIn and the processing system the permissions to transfer the user's data stored there to the processing system.
Information about the user obtained from the internet.
Browser history and other activity logs located on a personal electronic devices, websites, etc.
User activity e.g.
   Eye movements e.g. by eye tracking software
   Cursor movements and/or dicks
   Physical location(s) of the user
   Webcam or other camera output
   GPS data
   Data from one or more sensors located on a personal electronic device (e.g. smartphone, laptop computer, tablet computers, wearable devices, etc.)
User inputted Information (e.g. user fills out a form)
DNA sequence, height weight, medical records, and other health related information
Items of user's interest e.g. research papers, articles, photos, videos, etc.
Other structured data of a specific formatting

Examples of parsing technologies and tools that can be used in the present invention include, but are not limited to:

1. PDF PARSERS: In one embodiment, parsing engine 108 comprises one or more PDF Parsers which may be used to read files in PDF format and convert the file content into, for example, storable text data, which may be further used to convert to more meaningful data. Multiple tools may be integrated into the parser module to read this data. Examples of tools that can be used include, but are not limited to:

Language: C++

XPDF, PoDoFo, FlateDecode

Language: Java

Tools PDFBox

PHP Based PDF Parser PDF Parser etc.

Python: PyPDF2

2. WORD DOCUMENT PARSERS: In one embodiment, parsing engine 108 comprises one or more Word document parsers that read data stored in files in Microsoft Word document format and store transactional data as well as metadata in a document oriented database. Examples of tools that can be used include, but are not limited to:

Python based Word Document Parsers: python-docx and Ixml

C# Based Word Document parsers: DocX

3. EXCEL PARSERS: In one embodiment, parsing engine 108 comprises one or more Excel Parser that read data stored in files in xls and xlsx formats and store transactional data in the database along with the metadata about the files that are uploaded. Examples of tools that can be used include, but are not limited to:

Python based Excel parser: excel-parser

Perl based Excel Parser: Spreadsheet:ParseExcel

Java: Apache POI

PHP: PHPExcel

4. OCR PROCESSORS: In one embodiment, parsing engine 108 comprises Optical Character Recognition based image processors that convert the data from photos (e.g. photos of bills, receipts, etc.) and extract transactional data along with the metadata and store it in a database. OCR technology can be implemented using tools including, but not limited to: VueScan, FreeOCR, Capture2Text or a custom application.

Data 110 extracted by parsing engine 108 is mostly present in unstructured or semi structured format. Extracted data 110 of a specific user may be stored in a noSQL or non-relational database. Text extracted from user submitted documents may be stored in any of the databases including, but not limited to:

1. Documents based databases: Apache CouchDB, MongoDB, etc.

2. Graph based databases: MarkLogic, OpenLink Virtuoso, etc.

The software implementation of these databases may be done using Java, C++, C#, python etc.

Extracted data 110 may comprise user information including, but not limited to:
Personal Information—Title, First Name, Middle Name, Last Name, Birth Date, Age, Gender, Maiden Name, religion, family details, and other demographic information, etc.
Ethnicity—race, color, or creed
Online Profiles—Google, Facebook, LinkedIn, etc.
Employment Information—Company Name, Organization Type, address, employee size, Business Phone, Job Title, Functional Area, salary,
E-mail addresses
Phone Information—Phone numbers, FAX,
Address Information—Address Line 1, Address Line 2, City, State, Province, Zip, Country, County, Region, etc.
Privacy preferences—keep all activity private, keep some fields private, etc.
Education Information—School, Department, Degrees, Major, Graduation Year, etc.
Political affiliation—party typically voted, donations made to particular political causes, etc.
Financial profile—net worth, Tax ID number, spending pattern, assets owned, outstanding liabilities, current financial accounts,
Donation, gifting profile or other causes the user cares about
Subscriptions—e.g. subscriptions to online content online, magazines and other physical content, services such as gyms or educational services, etc.
User's tastes and preferences—expensive clothes (shops at Nordstrom) versus less expensive tastes (shops at Kohl's), restaurant/cuisine preferences,
User's spending pattern—amounts spent per month on items such as rent/mortgage, credit card payments, shopping, food, etc.
User's income profile—salary, investments, royalties, rents, other incomes
Health/healthcare status—type of health insurance, premium payments, hospital and other medical bills, pharmacy bills, other healthcare bills,
Insurance obtained—type of insurance, premiums,
Banking and other financial data—name of financial institution, type of product/service used, frequency and amounts of financial transactions,
Travel and leisure activities—frequency of travel, travel expenditure, restaurants and other leisure activities used and their expenses,
Services obtained—telephone services, internet connection, cable TV or other TV services,
Shopping activities—online and offline shopping history, stores frequented, expenses, frequency, etc.
Business Services and Product used
Locations frequented—offline or in-store purchase history, countries and regions visited,

FIG. 1 shows one embodiment of processing extracted data 110 using a Hadoop based Big Data analytics platform 112 for data processing, modeling and analysis. In this embodiment, processing of extracted data 110 may be done using several techniques, including, but not limited to:

1. User specific processing—In this embodiment, the unstructured/semi-structured data is processed using more advanced Big Data analytics techniques (MapReduce, Hive, and Pig). Template matching techniques are used to retain useful data and classify it into pre-defined categories that would constitute a user profile.

The above processing would generate the following user specific data which is then stored in Data Warehouse 114:

A. User Profile data—Age, Gender, Location etc.

B. User Budgets and Preference data—in different spend categories like Restaurants, Travel, Purchases, etc.

Data warehouse 114 is an accumulated collection of all the past data that is recorded till date. The data warehouse in this case will be collecting data into two main databases:

A. Spend Categories database 116—This database will have the classified data about the different categories where our users spend. These databases will also have the data related to the amount each user spend in each of these categories. An example of the data in this database would be a table named restaurant which will list down all the restaurants our users visit along with other parameters such as location of the restaurant, amount spent by each user, descriptive about the restaurant e.g. Chinese, Italian, Indian, economic etc.

B. User profile database 118—User profile will be containing a unique user identification number paired with the demographics and other specific criteria that will define the user e.g. user budget, average spend per transaction, monthly expenditure, location etc.

2. Advanced Data Analytics using Analytics Engine 120—In this embodiment, Analytics engine reads data from the data warehouse 114 and process the collection of data to create correlation among different datasets using predictive analytics tools (R, H2O, Orange, Anaconda). It will associate user profiles with most common characteristics and link all the spend categories together and create a larger dataset which can be used to expand the user profile to other areas of interest. In one embodiment, this is used to cross populate points of interest among a range of users with similar interests. The above processing would generate specialized data which is then stored in a specialized database 122. Examples of specialized data include, but are not limited to:

A. Analysis of data for all users that reveals varieties of user categories/groups and their preferences and commonalities.

B. Anonymized data that help the system extend offers and suggestions for a particular user using general trends and preferences of users having similar profiles.

Specialized database 122 may comprise all interrelated data which represents a user profile set. These sets may contain data across a range of categories that users with similar profiles are interested in. This database may also be utilized to store the spending patterns and consumer behavior while making purchase decisions for a group of users.

Any of the data analysis tools disclosed herein may be used to generate secondary information about the user including, but are not limited to:
Age can be extracted from email addresses—e.g. Yahoo email users are typically older than Gmail users.
A person who shops in ethnic (e.g. Chinese, Indian) supermarkets and resides in a location with a high concentration of ethnic people is more likely to belong to that ethnicity.
Donation/gifting profile can be used to determine causes the person cares about. E.g. a person who donates money to Catholic charities is more likely to be Catholic. E.g. a person whose credit card statement shows recurring payments to Stanford Alumni Association is very likely to be Stanford alum.
A person who subscribes to Nature and New England Journal of Medicine is very likely to be a doctor or someone from the healthcare industry.
A person with average utilities bill (e.g Pacific Gas & Electric bill) in zip code 95035 of >$200 per month is very likely to be a homeowner rather than a renter. A person with average utilities bill (e.g Pacific Gas & Electric bill) in zip code 95035 of >$600 per month is very likely to be a homeowner of a large house.
A person who regularly travels to Mexico and shops often in Hispanic stores is very likely to be of Mexican heritage
A person who regularly shops online for beauty products from women oriented stores is very likely to be a woman.
A person who shops for anti-aging products is likely to be older.
Shopping history from a particular vendor cane be used to determine if the person is likely to use that vendor. E.g. a person who shops regularly on Amazon is very likely to continue shopping with them.
Property tax and other government payments can be used to estimate the net worth of a person. E.g. a person who is paying high amounts of property taxes is very likely to be rich.
Tuition payments can be used to determine the educational institution the user or a family member is enrolled in.
A person's salary can be determined by recurring electronic deposits in a bank account.
Monthly incoming payments of same or similar amounts from one or more individuals to a user of a high net worth are very likely to be rent payments.
Purchase locations and times may be used to determine one or more of: travel history of the user, travel pattern of the user, typical locations of the user, typical commute of a user, vacation destinations, etc.

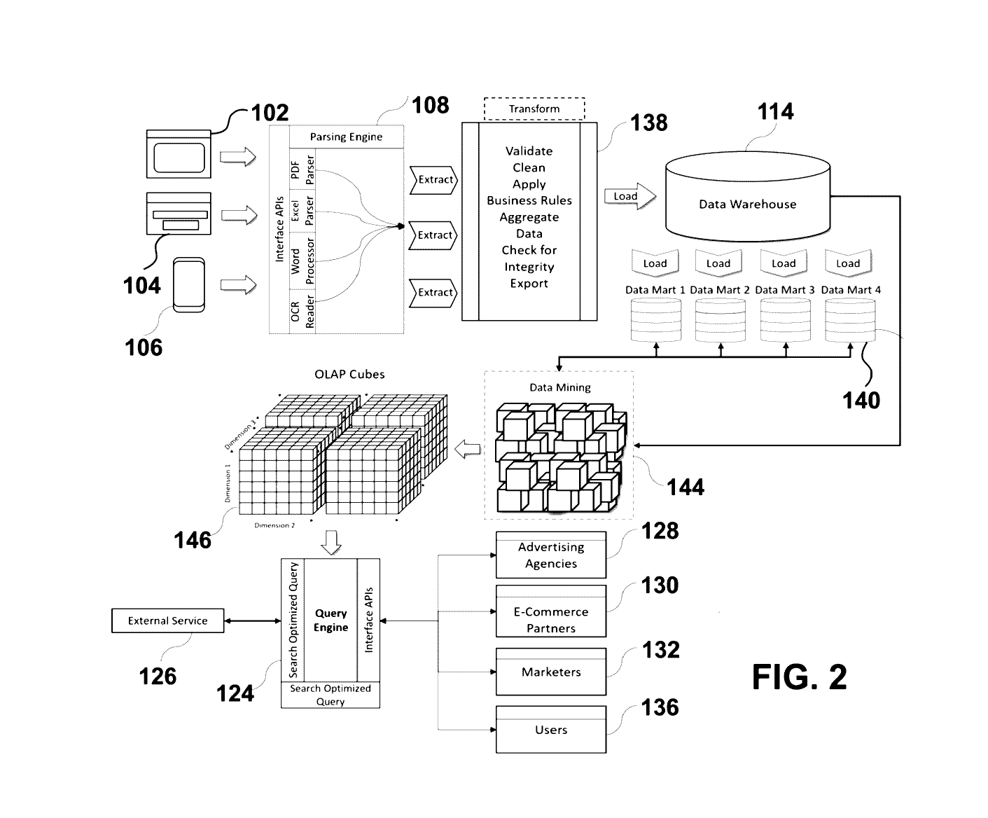

System 100 further comprises a query engine 124 for processing the queries coming from different partners including a search engine and present them data after querying the relevant components of system 100 including, but not limited to internal data warehouses 114, OLAP Cubes 146 (shown in FIGS. 2,3), etc.

In one embodiment, a query is processed to reveal the following information in form of keywords:

1. Search Category—What is the user looking for? For e.g. Restaurants, Hotels, Mobile Phones, Postpaid Plans etc.

2. Descriptive or Key Attributes—Keywords that would narrow the search category and describe them. For e.g. Chinese Restaurant, 3 star Hotels, Data Plans etc.

The Query Engine 124 can receive queries from different partners in the two forms discussed below:

1. Raw Queries—Query engine 124 can receive raw queries as entered by the user from partners which are then processed by the web server for keywords to enable extraction of relevant data from data warehouse 114.

2. Processed Keywords—Query engine 124 can receive specific keywords Instead of raw search queries after basic processing already done by the partners which are then transformed into a search query as per our database architecture by query engine 124.

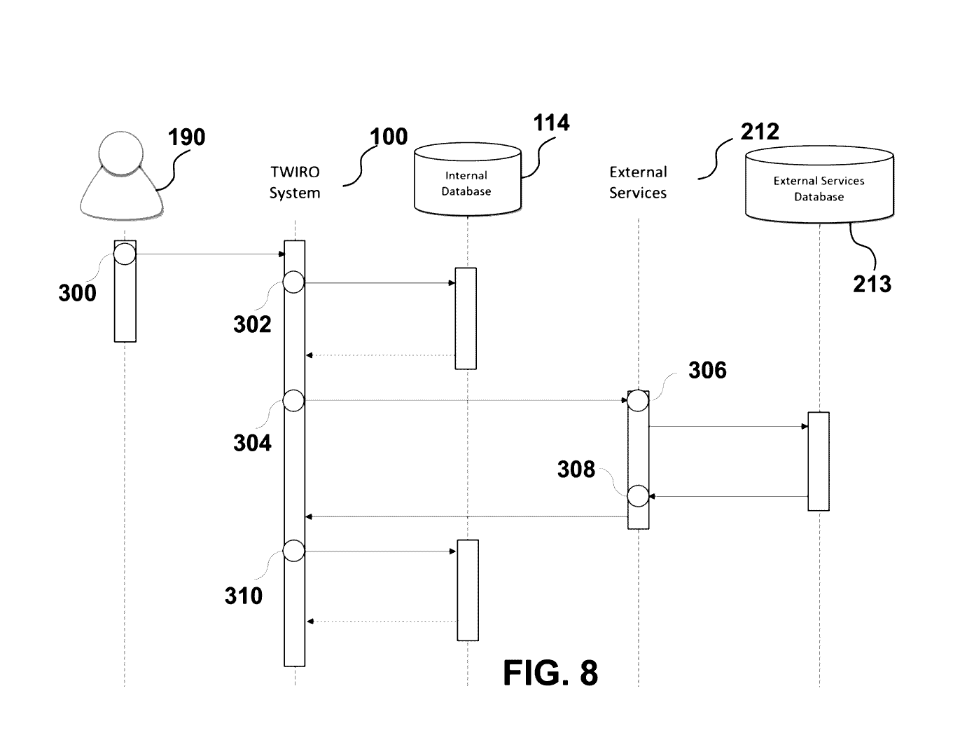

An external service provider 126 may be used to extend query results by providing information which is not readily present within TWIRO system 100 through secure web service calls. Two such embodiments are disclosed in FIGS. 8 and 9. In one embodiment, query engine 124 sends user's search query keywords and basic profile (age group, income group, location, gender etc.) in the format required by the external service provider 126 to enrich the search results.

The external services could also be used to enrich a particular user's profile through highly directed data extraction from these services using one or more data points mined from the data files provided by the user.

System 100 may also interface with one or more service partners that have tied up with the TWIRO Services. Examples of such service partners include, but are not limited to: Search Engines 198, Advertising agencies 128, E-Commerce Partners 130, Marketers 132, and Users 136.

Communication between service partners and query engine 124 is done through secure web service calls. In one embodiment, search query as entered by a user is converted into keywords understood by the TWIRO system so that relevant recommendations could be provided (refer FIG. 1, FIG. 2). Further with the aid of TWIRO system plug-ins, user identification key may be supplied by the service partners so that the system can find that specific user.

Communication between the service partners and TWIRO system may be facilitated through search frameworks which will communicate over secure channels with preformed queries.

In one embodiment, the results (products and services relevant to the user based on the search keywords) provided by the TWIRO system are merged and ranked with the results that the service partners would already have in their database to align with user preferences.

In one embodiment of an extended approach, the TWIRO system adds to the keywords and returns an enhanced set of keywords that are used by the service partners to align the search in their database with user preferences. For e.g. If the user is searching for Restaurants and TWIRO system has the data that the user likes American and Italian restaurants, it could return these enhanced keywords back to the partners to improve the search results.

FIG. 2 shows a first alternate embodiment of the data mining system architecture of the present invention. In FIG. 2, an intermediary noSQL Database is not used. Data extracted from temporary files created in the parsing step is stored in a relational database after the Extract, Transform and Load step using the ETL Tools. Using transformation tools 138, data may undergo a series of data cleaning and validation steps. Thereafter, the data is classified as per the business rules and an integrity check is performed. Thereafter, the data is uploaded to a Data Warehouse 114. Examples of tools that may be used in this embodiment include, but are not limited to: Informatica—Power Center, OpenSys—CioverETL, Microsoft—SSIS, and IBM—DB2 Warehouse Edition. To make the data easily accessible and faster processing the data is then be loaded to intermediary Data Marts 140 upon classification as per the business rules.

Thereafter, the data is processed using high level analytics techniques. User profiles data may be analyzed using data mining and statistical analysis tools 144 to form patterns. Data mining will be used to associate different users and aggregate user profiles based on specific patterns and key attributes that define the relation among them. These parameters will then be used to collate information and prepare it for OLAP (On-Line Analytical Processing).

The data is segregated and stored into OLAP Cubes 146 for quick access via OLAP Queries. An OLAP Server sits on top of these OLAP Databases. These cubes allow much faster access and to the data which is more useful for making business decisions. This data will be made available to the Query Engine which can query the OLAP Server in the predefined process to fetch details relevant to a specific user or a range of similar users.

Examples of tools that may be used in this embodiment include, but are not limited to: Oracle—Analytic Workspace Manager (AWM), and Microsoft—SQL Server Analysis Services (SSAS).

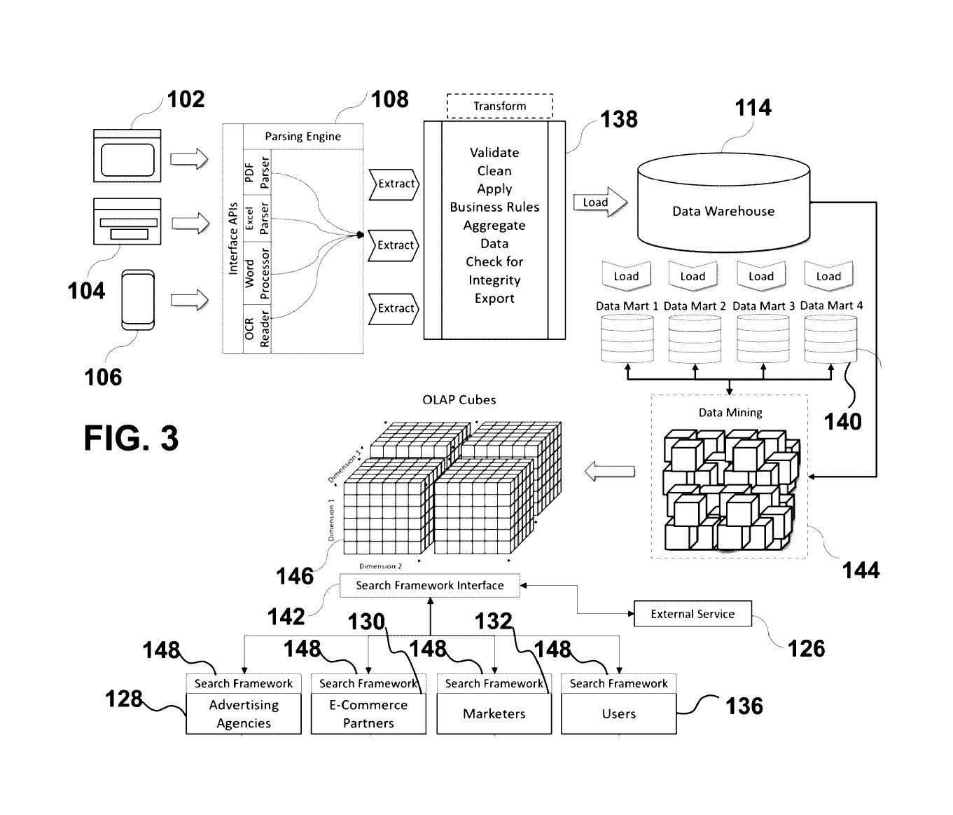

FIG. 3 shows a second alternate embodiment of the data mining system architecture of the present invention. In the embodiment of FIG. 3, instead of implementing a query engine 124, a search framework interface 142 is integrated into the system which would talk to a search framework of partners including, but not limited to: Search Engines 198, Advertising agencies 128, e-Commerce Partners 130, Marketers 132, and Users 136. Search framework 148 creates a query in a prescribed format for system 100 using keywords provided to it by the partner's system. This framework 148 takes keywords from the partner's system in a pre-communicated format e.g. spend category and the key attributes for the spend category. The framework 148 processes the inputs and performs checks to create a valid query for system 100. In one embodiment, a query formed comprises a user identifier, a spend category and the key attributes of that spend category.

Such a framework 148 can be made modular so that it can be ported/integrated into the partners' system and can work independently. This would provide a faster retrieval of data from the TWIRO Server as the query formation part is shifted to the partner's system.

Search framework communicates to search framework interface 142 implemented at the central server and transmit queries over a secure channel. The server will transmit back the results over the same secure channel.

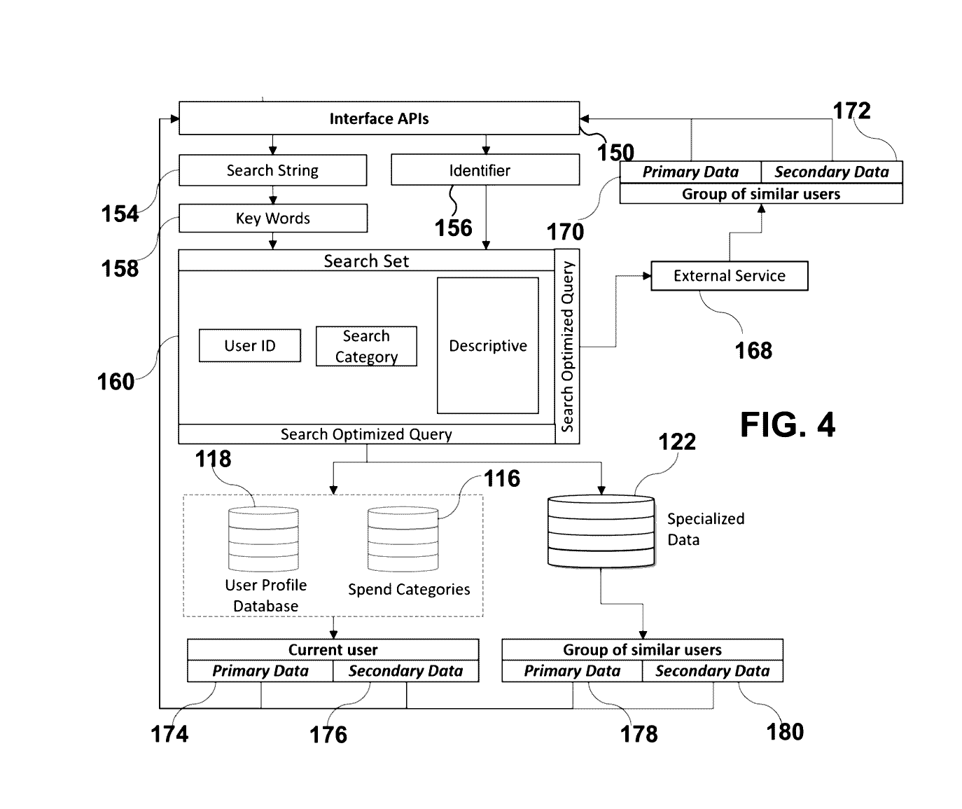

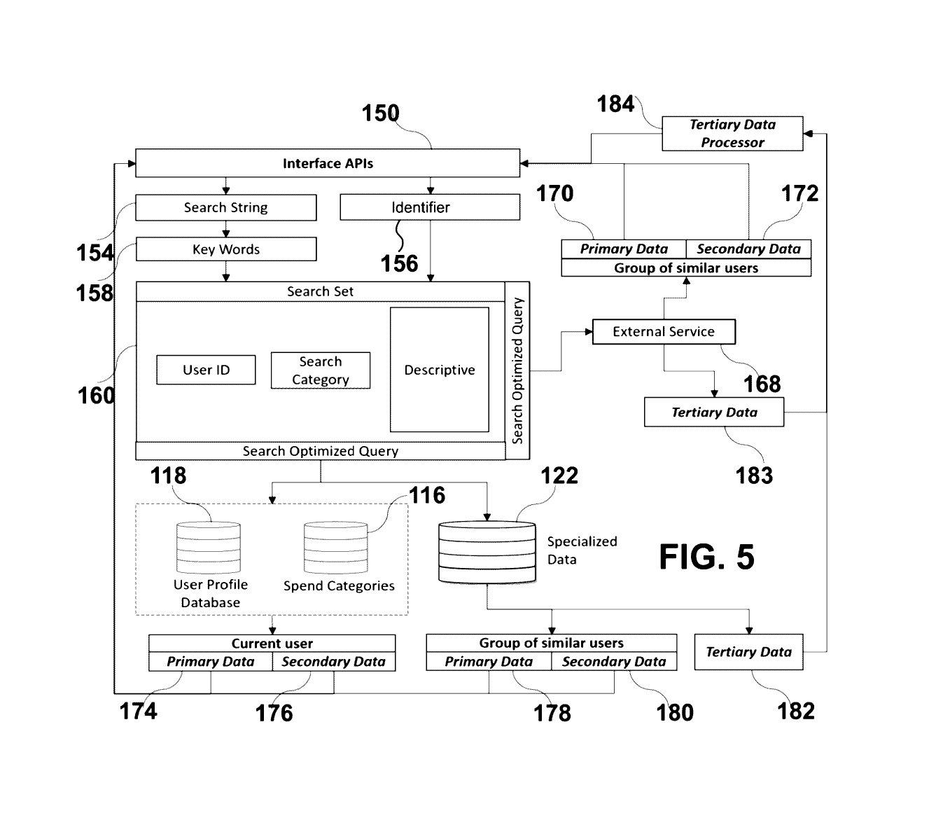

FIGS. 4 and 5 show two embodiments of data access interfaces. In these embodiments, the request for search query will come through an interface API 150. The search query comprises two parts: a search string 154 which can be a list of keywords 158 in a defined format and a user Identifier 156. These parts will combine together to form a search query. An optimized search query 160 will comprise the following parts:

1. User ID: This will be unique identifier for each user enrolled with the system

2. Search Category: These will be the categories across which the search could be performed. These will be defined and generated as a part of data extraction and analyses steps.

3. Descriptive: These will be the keywords that describe the product or service category that is being searched.

These queries will be run against the database(s) created in the data analysis steps. The database could be either a relational database with user specific details and specialized data (FIG. 1) or it could be an OLAP based database with specific details (FIG. 2, FIG. 3). The choice of query formation could be also based on the final selection of database implementation but will mainly consist of the parts described above.

In the first embodiment FIG. 4, the query would return the data as the listed categories below as per the levels of details and suggestions required by the partners.

1. Primary Data (170, 174, 180): Data pertaining to the Search Category and the specific descriptive for the given user 174. Data pertaining to the Search Category and the specific descriptive for the similar groups of users 172 and 180 from the Specialized Database 122 and External Service 168 respectively.

2. Secondary Data (172, 176, 180): Data pertaining to the Search Category and the extended descriptive for the given user 172. Data pertaining to the Search Category and the extended descriptive for similar groups of users 176, 180 from the Specialized Database 122 and External Service 168 based on trends and preferences of users from similar categories. For e.g. even though the user searched for “Chinese Restaurant”, we could all show results for “Thai/Vietnamese/Japanese Restaurants if our data analysis says that users who prefer Chinese restaurants could also like Thai/Vietnamese/Japanese restaurants.

In an extended embodiment of FIG. 5, the query would return Tertiary Data (182, 183) in addition to the Primary and Secondary data. In one embodiment, Tertiary Data (182, 183) is data pertaining to Related Search Categories and extended descriptive for similar groups of users 182 and 183 from the Specialized Database 122 and External Service 168 based on trends and preferences of users from similar categories. In this embodiment of FIG. 5, the tertiary data is processed through a Tertiary Data Processor 184 to narrow down the related search categories that the similar users are interested in to a parent category for the searched category to make the result set more relevant to the initial search query from the user. For e.g. If the user is searching for books, we could show offers on book shelves/cases, Kindle etc. that are categories related to books.

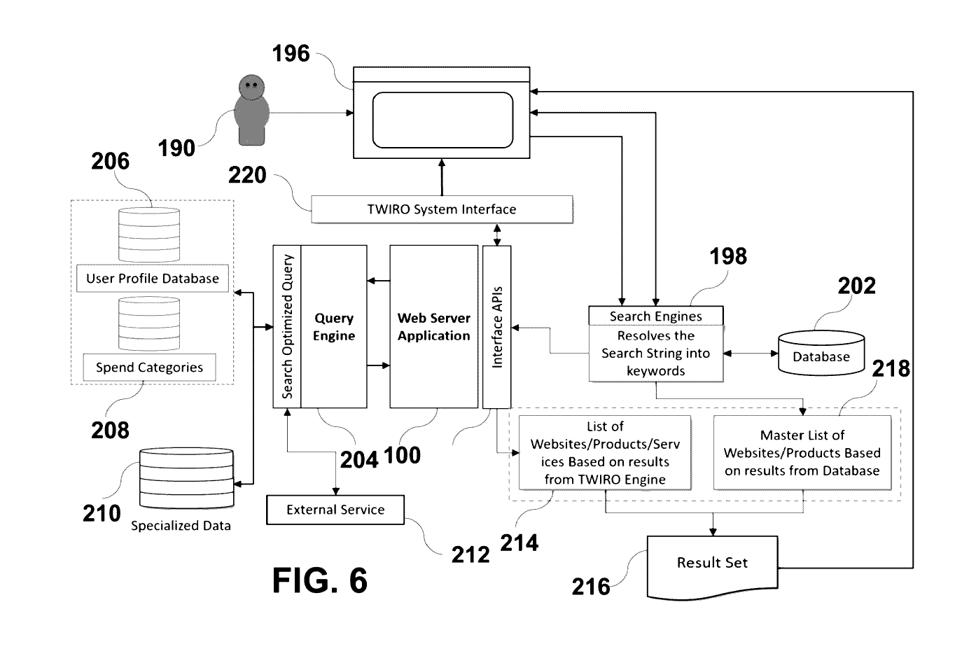

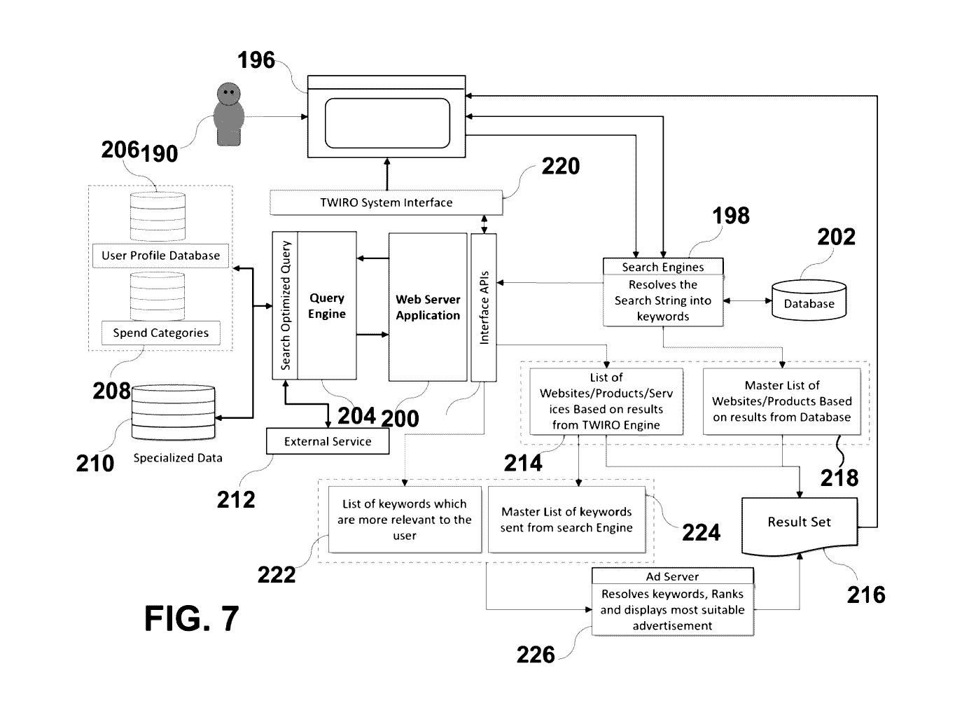

In one embodiment, the present invention is used as a service to a search engine that interacts with the system as shown in FIGS. 6 and 7. FIGS. 6 and 7 shows two embodiments of the architecture and the data flow of using the present invention to improve search engine results.

In FIG. 6, a user 190 enters a search query on a browser 196. Thereafter, the search query is sent to a search engine 198, which resolves the search query into keyword(s). Search engine 198 looks up cookies of browser 196 for a local cookie stored by TWIRO System as a user identification key and fetches it. Search engine 198 passes the keyword(s) and user identifier cookie to the TWIRO System 100 through the Interface APIs of the system 100. Interface APIs of the system 100 also authenticates the user 190 and search engine 198 through a system interface 220. Search engine 198 also runs the query against its own database 202 and creates a master list 218 of Website/Products that it would display to the user. Web Server application of the system 100 authenticates the user and sends the query to a Query Engine 204.

Query Engine 204 forms the query in the appropriate format and searches one or more databases including, but not limited to: databases comprising data specific to user 190 such as profile database 206 and spend categories database 208; databases comprising data related to a user profile such as specialized database 210 for user specific as well as associated data.

Query Engine 204 also queries an external service 212 to expand the search results, increase confidence and expand the available information about a specific user. In one embodiment, external service 212 provides comprehensive data as per user profiles.

Query Engine 204 then collates and returns the comprehensive dataset to a webserver application of system 100.

Webserver application of system 100 then returns the list 214 of products/websites which will be more relevant to user 190 since they are customized to user 190.

Search engine 198 then combines data from list 214 and master list 218 (e.g. by re-ranking/rearranging master list 218 as per list 214) to forms a final results set 216. Search engine 198 then displays results set 216 on a web page displayed by browser 196.

FIG. 7 shows an alternate embodiment wherein ad service providers are involved. In the embodiment shown, system 100 sends a list of keywords (e.g. keywords 222 more relevant to the user, master list 224 of keywords from search engine 198, etc.) to an ad server 226. The keywords may be rearranged or ranked (e.g. by re-ranking/rearranging master list 224 as per keywords 222) before being sent to ad server 226. Ad server 226 may perform one or more of the following actions: resolving keywords, ranking and displaying more relevant advertisements, etc. Output from ad server 226 forms a part of result set 216.

An external service may be used to extend the query results by providing the information which is not readily present with TWIRO Engine through secure web service calls. The external service may also be used to enrich a particular user's profile through highly directed data extraction from these services using known information about the user.

FIG. 8 shows one embodiment of a data flow of a system incorporating an External Service.

At step 300, a user 190 uploads his data (e.g. 2-3 months' credit card statement). User's information is updated in the system 100 along with the user profile as disclosed elsewhere in this specification. At step 302, system 100 queries an internal database 114 as disclosed elsewhere in this specification. Internal database 114 returns query results as disclosed elsewhere in this specification. At step 304, system 100 queries an external service 212 with particular data about the users which would narrow down to a particular user. External service 212 queries an external service database 213 and then returns the user's match and returns additional data about the user (e.g. the past credit card and other financial transactions history stretched over a couple of years). This additional data is then integrated with the existing user profile at step 310 to expand the user profile, which in turn may be used to perform any of the actions disclosed herein including, but not limited to: make better predictions and model user behavior.

FIG. 9 shows another embodiment of a data flow of a system incorporating an External Service. In the embodiment shown in FIG. 9, steps 300 and 302 are similar to those in FIG. 8. In step 312, system 100 queries Internal Database 114, reads the user transactions and classifies them as a set of activities. These activities could be a future set of activities the user might be engaged in or if a repeating pattern is found will be classified as an activity user would be interested in. At step 314, system 100 queries external service 212 with the list of activities along with the location data. At step 316, the external service 212 queries the external service database 213 with this list. At step 318, the external service database returns the entire list of activities that the similar users are interested in. At step 320, these related activities are returned to the system 100 referred as Points of Attraction. Subsequently, when the next time the user comes online or searches for a product as shown in step 322, system 100 at step 324, passes this list of Points of Attraction as per the user profile to the ad servers/search engines 318 or to other entities or components disclosed herein. The ad servers/search engines 318 or other entities or components can then display the best offers or packages to user 190 or perform one or more functions disclosed herein.

FIG. 9A shows a flowchart of a method of adding data from an external secured database to the user's profile stored on a TWIRO system without compromising the security of the database. In FIG. 9A, financial transactions and secured financial databases are used as an example only. At step 330, user provides financial information (e.g. credit card statements in the PDF format) to the system 100. Examples of upload mechanisms are disclosed in FIGS. 1-3. Thereafter, at step 332, system 100 stores the user-provided financial information. Thereafter, at step 334, system 100 extracts one or more data points from the financial information. Examples of such data points include, but are not limited to: user's name, address and other personally identifying information; transaction details such as data, vendor, amount, etc.; and financial information such as statement balance, credit limit, etc. Examples of systems and methods for extracting these data points are disclosed elsewhere in this specification, including in FIGS. 1-3. Thereafter, the data points are provided to another system or a sub-system of system 100 that communicates with an external database. At step 336, system 100 compares extracted data points against a secured external database. At step 338, system 100 receives additional data points from the external database. Thereafter, at step 340, system 100 adds additional data points to an internal database, several examples of which are disclosed in this specification.

In one embodiment of a method similar to that of FIG. 9A, one or more data points of a user are provided to a system similar to Offer Management System 211 of FIGS. 2 (shown as FIG. 9B) and 3 of U.S. Pat. No. 8,438,061, the entire disclosure of which is incorporated herein by reference. Thereafter, using an architecture similar to that shown in FIGS. 2 and 3 and other parts of the specification of U.S. Pat. No. 8,438,061, an external database (e.g. a financial institution database) is accessed to obtain additional data points about the user (step 336). Thereafter, using a system similar to Offer Management System 211 of FIGS. 2 and 3 of U.S. Pat. No. 8,438,061, data points about the user are communicated back to system 100. Any of the financial transactions (e.g. credit card transactions) may be accessed before the generation of a statement (e.g. a credit card statement).

FIG. 9C shows a table of data extracted from a credit card statement showing the user's financial transactions with a particular hypothetical store. The system can identify or extract one or more unique user identifiers from the credit card statement. One or more of these user identifiers may be processed as per the method of FIG. 9A. The identifiers are then matched to a second database containing one or more electronic data relating to the user's transactions to identify the user and/or transactions associated with the user. Thereafter system 100 adds the transactions and/or one or more secondary data relating to the transactions (examples of which are disclosed in this specification) to build the user's profile.

Examples of user identifiers that can be identified and/or extracted from the user provided information include, but are not limited to:

1. User's name

2. User's address

3. One or more identifiers of the financial institution

4. Account number(s) or other account identifiers

5. Transaction location

6. Transaction date

7. Transaction description

8. Vendor

9. Transaction amount(s)

10. Transaction identifiers (e.g. Reference Numbers)

and combinations thereof.

In one such embodiment, a set of user's purchases such as shown in FIG. 9C from a particular vendor (e.g. Wal-store) from user provided electronic credit card statements are matched with a database containing credit card transactions to identify transactions related to a particular user (e.g. by searching for the user/credit card associated with the purchase amounts of $45.23, $21.83. $90.72, and $176.52 with WAL-STORE in Palo Alto, Calif. in the year 2015). In another embodiment, transaction reference numbers are used to identify transactions related to a particular user. Once the user/user's transactions are identified, additional data points about the user are obtained by searching the secured database.

Once system 100 links/matches the user to a set of transactions, the user's profile may be prospectively updated at one or more times based on prospective electronic data related to one or more prospective transactions. In one such embodiment, the user's prospective financial transactions are used to prospectively update the user's profile. In another such embodiment, the user's prospective updates to a social media profile or webpage are used to prospectively update the user's profile.

A similar architecture may be used to add rewards to user's financial accounts based on user activity using system 100 or one or more products or services that partner with or otherwise use system 100. In one such embodiment, a user performs an action that leads to a reward. The rewards are credited to an external database (e.g. a financial institution database) using methods similar to those disclosed in the specification, especially in FIGS. 9A-9B. Examples of such actions include, but are not limited to: availing an offer tailored to the user, clicking on a hyperlink such as an advertising hyperlink, performing one or more actions tailored to the user using system 100, etc. In one particular example, the user is offered a cash reward customized using system 100. The user purchases a particular product or service. Information about the purchase including data identifying the user is sent to system 100. System 100 then communicates with an external database (e.g. a financial institution database) and the cash reward is credited to a financial account of the user. In another particular example, the user is offered a more beneficial financial product or service using system 100. The user accepts this offer. Information about the acceptance including data identifying the user is sent to system 100. System 100 then communicates with an external database (e.g. a financial institution database) and the user is provided with the more beneficial financial product or service.

FIGS. 10 and 11 show two embodiments of a system comprising a social media interface. Using these embodiments, users can add data to their TWIRO profiles from their social media accounts (e.g. by registering with their social media accounts in the TWIRO system). This would allow system 100 to dynamically follow user preferences and regularly update their profiles (e.g. as shown in FIG. 11). Such social media interfaces may be used to add user information including, but not limited to: places the users are visiting, eating at and the products they are interested. Such data may be utilized by system 100 and partners (e.g. Ad Agencies, Search Engines) to align their offers/results to user preferences and or other applications disclosed elsewhere in this specification.

As the user registers or otherwise links his social media account with the TWIRO System 100 (e.g. through a user interface 102), the system will access the user's social profile, user likes and group affiliations, etc. This information will be used by the system 100 to build a user profile which has more dimensions. This will be dubbed along with other information (e.g. financial transaction information), which in turn may be analyzed to form more related patterns and better serve the users as disclosed elsewhere in this specification.

As a further extension (FIG. 10), the user's check-ins 402 e.g. in a Facebook account could be used to by TWIRO system partners like Ad agencies/Travel Agents to offer discounts and new plans to the users next time they log into the TWIRO system or when they subsequently perform a search on a search engine.

The user registers or otherwise links his social media accounts with the TWIRO system 100. The TWIRO System will access the user's Check-in location data and update the database 404 with the information. Whenever the ad servers 226 come against a query by the user, this information can be sent to the ad servers 226 upon request. The ad server 226 can then display the offers for the specific locations which the user might be interested in.

Login free access may be provided to a user through one or more embodiments disclosed herein while still offering customized products/services to the user. An external service may be provided user's information by system 100 in an anonymized or non-anonymized form.

System 100 may comprise means to enable the user to edit/delete/add profile fields. Profile fields stored in a database may be in a standardized format.

Any of the embodiments herein may be used with private search engines or search engines that don't track a user such as DuckDuckGo, Yippy, Ixquick, etc.

Single action transfer of information in one or more components of system 100 to an external partner without login/app/download may be done e.g. drag and drop, click on hover button, enter profile code, QR code or other codes, drag and drop a profile code, etc. This action may be performed in an anonymous/private mode.

A temporary profile code may be generated instantly to ensure the user's privacy. The temporary profile code may be used for one or more of: obtaining login-free access to a product/service while providing the product/service with user information, accessing the user's information in system 100, and other actions disclosed elsewhere in this specification.

In one embodiment, a user accesses his information stored in system 100 across multiple platforms across multiple physical locations e.g. his personal smartphone, his office smartphone, his personal laptop/tablet, his office laptop/tablet, etc.

The information stored in system 100 may be combined with a “mood field”. E.g. the user enters moods such as:

“Going clothes shopping this Saturday”

“Ethiopian food tonight”

“Want to buy a townhome in San Jose Calif. this year”

System 100 or a partner then displays relevant advertisements or uses information from the mood field and system 100 to generate useful information for the user or to a third party who in turn can provide information to the user. The moods may be changed by the user one or more times.

System 100 may store one or more profiles of a user. The profiles may be accessible by variety of means e.g. app, database, login, plugin, browser add on, browser, etc. The user may select and use a particular profile as needed.

Some examples of modifying output of external products or services using present invention are as follows:

1. Output of a search on an electronic map (e.g. Google Maps) for restaurants in a city may be modified to show/highlight restaurants that match a user's tastes, budget, location, etc., instead of showing all/unfiltered restaurant types. E.g. a user who has visited Mexican and Chinese restaurants in that city or surrounding areas and spent $20-$40 per visit may be shown such restaurants.

2. Online ads may be tailored to a user's tastes based on information from his profile stored on system 100. E.g. a person who has subscribed to sports packages on TV or other streaming services may be shown sports related ads. A person who has signed up for ethnic TV packages (e.g. Indian/Mexican/Chinese TV packages) may be shown ads relevant to a person of such an ethnicity.

3. The search results of a search engine with the search query “shop clothes online” may be modified to show more results from high end stores to a user who has visited e.g. Nordstrom (or equivalent high end stores) in the past.

All trademarks or proprietary names used herein belong to their respective owners and are used only for purposes such as giving examples of technologies that may be used to build the present invention, define the use environment of the present invention, etc.

Although several embodiments of the invention are disclosed herein, various modifications (e.g. additions, deletions), combinations, etc. may be made to examples and embodiments herein without departing from the intended spirit and scope of the invention. Any element, data structure, data point, database, processing method and/or architecture, information, method step or attribute of one method or device embodiment may be incorporated into or used for another method or device embodiment, unless to do so would render the resulting method or device embodiment unsuitable for this invention. For example, several data mining system embodiments are possible wherein the data mining and/or data processing architecture of one embodiment disclosed herein is added to another embodiment disclosed herein unless doing so would render the resulting embodiment unsuitable for its intended use. Any suitable information or database or processing step disclosed herein may be used to perform any of the methods disclosed herein. If method steps are disclosed in a particular order, the order of steps may be changed unless doing so would render the method embodiment unsuitable for its intended use. A method step described herein may be added to or used to replace a step of another method embodiment described herein. A system or method embodiment that is used for one product or service may be used for another product or service. Various reasonable modifications, additions and deletions of this invention's examples or embodiments are to be considered equivalents of the described examples or embodiments.

1. A data mining system architecture for processing user data for use with a search engine comprising:
a. a secure cloud server comprising a processor and data storage means hosting a parsing engine for extracting data from user submitted data files;
b. a data analysis system comprising one of: a Hadoop based data analytics platform, an analytics engine communicating with a data warehouse, and statistical analysis tools to aggregate user profiles based on patterns;
c. an internal user profile database comprising one or more user profiles, and
d. a query engine comprising an application programming interface to communicate with, and receive queries from the search engine external to the data mining system.

2. The data mining system architecture of claim 1, further comprising a data warehouse that communicates with the data analytics platform and stores the data output of the data analytics platform.

3. The data mining system architecture of claim 1, further comprising a specialized database communicating with the analytics engine wherein the analytics engine reads data from the data warehouse and generates specialized data which is then stored in the specialized database.

4. The data mining system architecture of claim 1, further comprising an Extract-Transform-Load (ETL) tool and one or more data marts, wherein the user data is stored in the one or more data marts after processing by the ETL tool.

5. The data mining system architecture of claim 4, further comprising an OLAP (On-Line Analytical Processing) server sitting on top of one or more OLAP databases.

6. The data mining system architecture of claim 1, wherein the query engine further comprising a second application programming interface that sends user's search query keywords and basic profile information to an external service provider.
